(19) United States
(12) Patent Application Publication
(10) Pub. No.: US 2018/0098112 A1
(43) Pub. Date: Apr. 5, 2018

(54) CONTROL TERMINAL, SYSTEM, AND METHOD OF CONTROLLING SYSTEM

(71) Applicant: YAMAHA CORPORATION, Hamamatsu-shi (JP)

(72) Inventors: Akihiko Suyama, Hamamatsu-shi (JP); Kazuya Mushikabe, Hamamatsu-shi (JP); Keisuke Tsukada, Hamamatsu-shi (JP)

(21) Appl. No.: 15/831,695

(22) Filed: Dec. 5, 2017

Related U.S. Application Data
(63) Continuation of application No. PCT/JP2016/078007, filed on Sep. 23, 2016.

(30) Foreign Application Priority Data
Sep. 30, 2015 (JP) 2015-194508

(51) Int. Cl. H04N 21/43; H04R 3/12; H04N 21/436; H04N 21/658; H04W 84/12; H04W 88/08

(52) U.S. Cl. CPC H04N 21/4302; H04R 3/12; H04W 88/08; H04N 21/658; H04W 84/12; H04N 21/436

(57) ABSTRACT

A system including a control terminal, and a method of controlling a plurality of devices, including a first device and a second device that is different from the first device. The method of controlling the system includes receiving a group setting for the first device, which has a main channel and a sub channel, and setting the main channel and the sub channel as respective separate groups.

### CROSS REFERENCE TO RELATED APPLICATIONS

The present application is a continuation application of International Patent Application No. PCT/JP2016/078007, filed on Sep. 23, 2016, which claims priority to Japanese Patent Application No. 2015-194508, filed on Sep. 30, 2015. The contents of these applications are incorporated herein by reference in their entirety.

### BACKGROUND OF THE INVENTION

### 1. Field of the Invention

The present invention relates to a control terminal configured to control a plurality of audio devices, an audio system thereof, and a method thereof.

### 2. Description of the Related Art

In recent years, a portable terminal device is configured to control an operation, such as content playing, of each audio device contained in an audio system with a plurality of audio devices (play devices) arranged in each room (area), such as a living room or a bedroom, connected to a network (wireless network, in particular). See Japanese Unexamined Patent Application Publication No. 2013-251594, for example.

The user, by operating the portable terminal device, can cause one selected audio device to execute content playing or the like. In addition, the user, by operating the portable terminal device, can also specify (select) a plurality of audio devices to perform group setting. Then, the user can also cause the audio devices that belong to a group to synchronously play the same content.

Of devices having a plurality of audio output channels, some devices having a function (called as “zone function”) of using an extra play channel (sub channel) and performing simultaneous playing of the content of a main channel in a different room have been put into practical use.

### SUMMARY OF THE INVENTION

The present invention is directed to controlling group play in a plurality of audio devices including a device having a plurality of audio output channels.

One aspect of the present invention is a control terminal. The control terminal includes at least one memory storing instructions and at least one processor. The at least one processor is configured to implement the stored instructions and execute a plurality of tasks. The at least one processor executes a receiving task and a transmitting task. The receiving task receives a group setting for a first device having a main channel and a sub channel, from among a plurality of devices, and sets the main channel and the sub channel as respective separate groups. The transmitting task transmits a command related to the group setting to at least the first device.

Another aspect is a system that includes the control terminal and the plurality of audio devices.

Another aspect is a method of controlling the system.

Even when a device that has a plurality of audio output channels, the present features allow a group playing using a conventional group play operation.

The above and other elements, features, characteristics, and advantages of the present invention will become more apparent from the following detailed description with reference to the drawings.

### BRIEF DESCRIPTION OF THE DRAWINGS

FIG. 1 is a diagram illustrating a configuration of a network connection of an audio system 10.

FIG. 2 is a diagram illustrating an arrangement of each audio device of the audio system 10.

FIG. 3 is a block diagram of an audio device (single zone device).

FIG. 4 is a block diagram of an audio device (multi zone device).

FIG. 5 is a block diagram of a portable phone that functions as a controller.

FIG. 6 illustrates an example of a system management table that is set to a master device and a controller.

FIG. 7 illustrates an example of an audio control table that is set to the controller.

FIG. 8 is a diagram illustrating a general configuration of group playing.

FIG. 9 is a diagram illustrating an input and output of an assigner of the multi zone device.

FIG. 10 is a diagram illustrating an example of a group including the multi zone device.

FIG. 11 is a diagram illustrating an example of a group including the multi zone device.

FIG. 12 is a diagram illustrating an example of a group including the multi zone device.

FIG. 13 is a diagram illustrating an example of a group including the multi zone device.

FIG. 14 is a diagram illustrating an example of a group including the multi zone device.

FIG. 15 is a diagram illustrating an input selection table of a group including the multi zone device.

FIG. 16A illustrates an example of a room selection screen illustrating a procedure of group setting in the controller, FIG. 16B illustrates an example of a master room selection screen in the controller, and FIG. 16C illustrates an example of a client selection screen in the controller.

FIG. 17A illustrates another example of a room selection screen illustrating a procedure of group play in the controller, FIG. 17B illustrates another example of a source selection screen in the controller, and FIG. 17C illustrates an example of a play screen in the controller.

FIG. 18 is a flow chart illustrating processing operation at a time of the group play of the controller.

### DETAILED DESCRIPTION

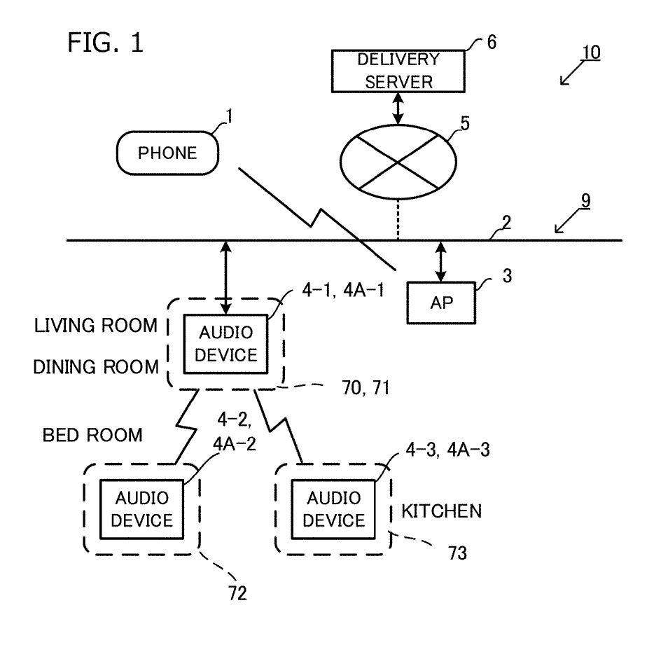

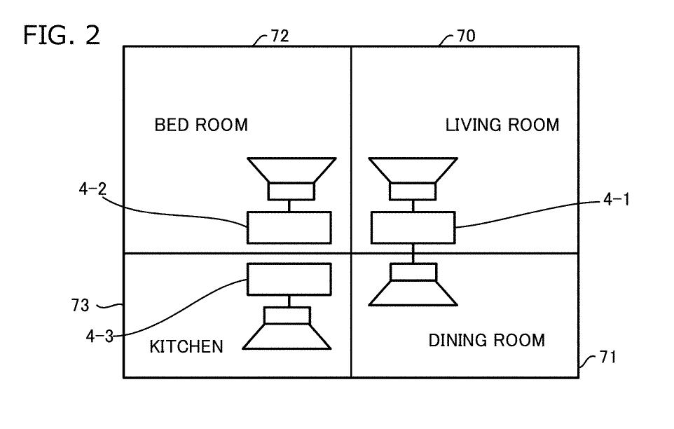

FIG. 1 illustrates a configuration of a network connection of an audio system 10. FIG. 2 illustrates an arrangement of each audio device of the audio system 10.

The audio system 10 has three sets of audio devices 4 (4-1, 4-2, and 4-3) that are respectively installed in separate rooms (Rooms). The audio device 4-2 and the audio device 4-3 are single zone devices, and are respectively installed in a kitchen (Kitchen) 73 and a bedroom (Bed Room) 72. The audio device 4-1 can be a multi zone device that covers a plurality of (two in the present preferred embodiment) rooms. The audio device 4-1 is installed in a living room (Living Room) 70 in the present example, and outputs sound to the living room as zone 1 corresponding to a main channel. Furthermore, the audio device 4-1 is able to output sound to a dining room (Dining Room) 71 as zone 2 corresponding to a sub channel.

In addition, the audio system 10 has a multifunctional portable phone (portable terminal device) 1 (hereinafter referred to as a controller). The audio devices 4 (4-1 to 4-3) and the portable phone 1 are connected to each other in a network 9 including a wired LAN 2 and an access point (external access point) 3. Each of the audio devices 4 transmits and receives an audio signal mutually through the network 9. The controller 1 can transmit a command message to at least one of the audio devices 4 through the network 9.

Each of the audio devices 4 in the audio system 10 has a wired LAN function and two wireless LAN functions. Each of the audio devices 4 can start an access point using one of the two wireless LAN functions. The access point started by each of the audio devices 4 is called an internal access point 4A. The internal access point 4A is connected to lower-level audio devices 4. The other wireless LAN function functions as a slave machine of the wireless LAN, and is connected to the internal access point 4A of higher-level audio devices 4 or an external access point 3.

The wired LAN 2 is connected to the access point (external access point) 3. The audio device 4-1 is connected to the wired LAN 2 with a cable. The audio device 4-2 and the audio device 4-3 are connected to an internal access point 4A-1 of the higher-level audio device 4-1 by the wireless LAN. It is to be noted that a new one of the audio devices 4 can be further connected also to the lower-level of the audio device 4-2 and the audio device 4-3, and a new one of the audio devices 4 can be further connected also to the external access point 3.

The network 9 can be configured by the wired LAN 2, the external access point 3, and the wireless LAN, including the internal access point 4A. The wired LAN 2 can use, for example, Ethernet (registered trademark: IEEE 802.3). The wireless LAN can use Wi-Fi (registered trademark: IEEE 802.11g). Moreover, the network 9 can be connected from the wired LAN 2 to a delivery server 6 through the Internet 5. The delivery server 6 can deliver music data to the audio devices 4.

Each of the audio devices 4 is called a root device, a node device, a leaf device, or a branch device, according to the configuration of the connection to the wired LAN 2. The root device is the top-level device connected to the wired LAN 2 directly (with a cable), and the audio device 4-1 is a root device in FIG. 1. The root device is an audio device that has first been registered at the time of configuration of the audio system 10, and serves as a reference point of the audio system 10. The root device starts the internal access point 4A to connect the lower-level audio devices 4 to the network and causing the lower-level audio devices 4 to participate in the audio system 10. The music information that is reproduced by the audio devices 4 (a node device and a leaf device) connected below (to the lower-level) the root device is all transmitted through the root device.

The node device is a middle-level device connected to the root device (internal access point 4A of the root device) by the wireless LAN, and the audio device 4-2 and the audio device 4-3 are node devices in FIG. 1. The node device starts the internal access point 4A to connect the lower-level audio devices 4 to the network and causing the lower-level audio devices 4 to participate in the audio system 10. The music information that is reproduced by the audio devices 4 (a leaf device) connected below the node device is all transmitted through the node device.

In addition, the leaf device is a lower-level device connected to the node device (internal access point 4A of the node device) by the wireless LAN. Furthermore, one of the audio devices 4 connected to the external access point 3 is called a branch device.

Although each of the audio devices 4-1 to 4-3 of the audio system 10 can individually play a separate audio source (content), in the audio system 10, a plurality of audio devices can be grouped. The grouped audio devices synchronously play content that played from the same audio source. The content can be music, for example. The music is stored as music data, in an audio source such as a CD or a hard disk that are included in each of the audio devices 4-1 to 4-6. The file format of the music data can be MP3, WAV, SoundVQ (registered trademark), WMA (registered trademark), or AAC, for example.

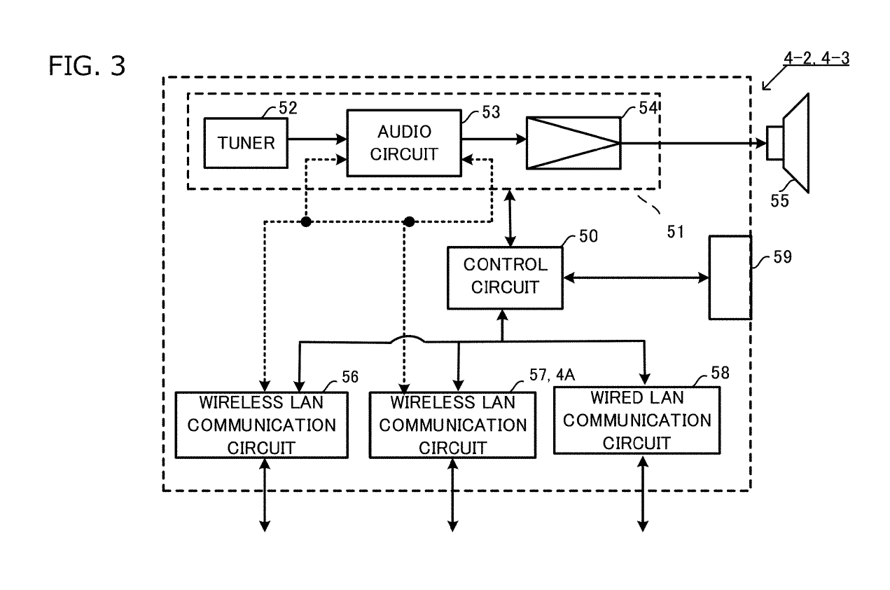

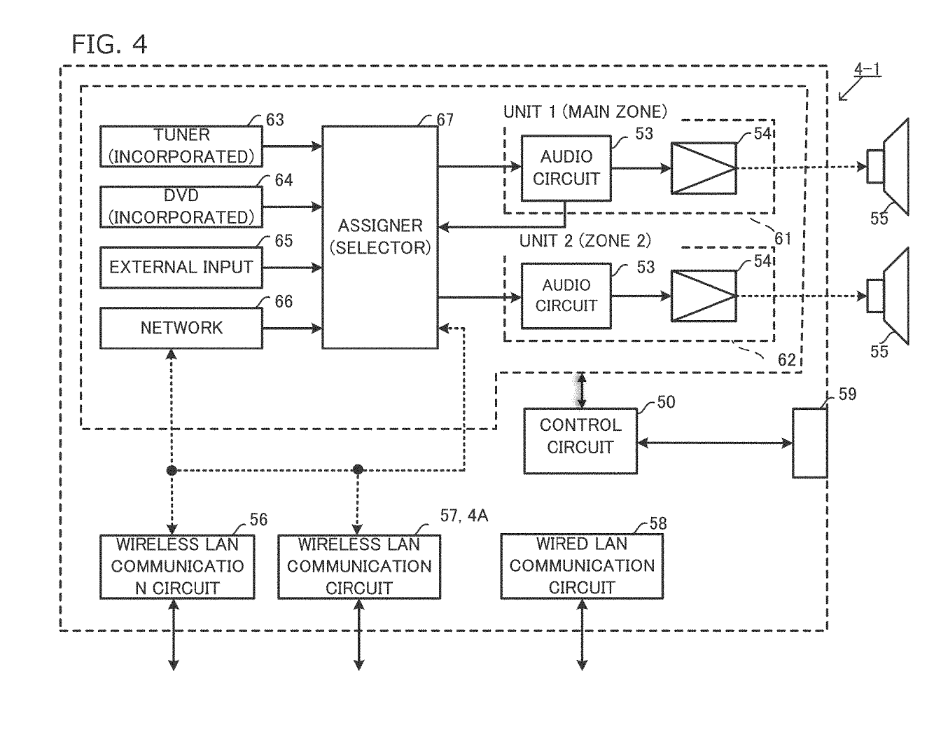

Subsequently, a description will be made of a configuration of one of the audio devices 4 with reference to FIG. 3 and FIG. 4. FIG. 3 is a block diagram illustrating the configuration of an audio device (single zone device: the second audio device) 4-2 and an audio device 4-3 in a single zone. In FIG. 3, the audio device 4-2 and the audio device 4-3 (hereinafter collectively referred to simply as audio devices 4) in a single zone each have a control circuit 50, an audio processing circuit 51, and an operation circuit 59. Each of the audio devices 4 in a single zone further has a wireless LAN communication circuit 56, a wireless LAN communication circuit 57, and a wired LAN communication circuit 58. The operation circuit 59 includes a volume operation element. The control circuit 50 includes a CPU and a memory and stores an audio system program. The control circuit 50, by the audio system program, controls the operation of the audio processing circuit 51, the wireless LAN communication circuit 56, the wireless LAN communication circuit 57, and the wired LAN communication circuit 58.

The operation circuit 59 and the control circuit 50 can be executed by at least one processing circuit, such as a CPU (Central Processing Unit) or a DSP (Digital Signal Processing).

The wireless LAN communication circuit 56 performs wireless communication by the wireless LAN standards such as IEEE 802.11g with the external access point 3 or the internal access point 4A of the higher-level audio devices 4. The wireless LAN communication circuit 57 is started as an access point (internal access point 4A), and relays other audio devices (audio device 4-2 and audio device 4-3, for example) to the wired LAN 2. Further, the wireless LAN communication circuit 57 is started as a temporary access point for initial connection also at the time of initial connection of one of the audio devices 4, and communicates with the controller (portable phone 1). The operation at the time of initial connection will be described below. It is to be noted that both the wireless LAN communication circuit 56 and the wireless LAN communication circuit 57 can operate in one piece of hardware in a time-sharing manner. The wired LAN communication circuit 58 has a cable connector, and performs communication by the communication standards such as IEEE 802.3 through the wired LAN 2. The controller 1 is connected to the access point 3. The control circuit 50 communicates with the controller 1 through the network 9, and transmits an operation state and receives a command message.

The audio processing circuit 51 has a tuner 52, an audio circuit 53, and a power amplifier 54. The tuner 52 receives an audio signal from an FM broadcast or the Internet, and inputs the audio signal into the audio circuit 53. The audio circuit 53, after performing an audio processing, such as equalizing or volume adjustment, to an input audio signal, outputs a processed audio signal to the power amplifier 54. The power amplifier 54 amplifies the input audio signal, and outputs an amplified audio signal to a speaker 55 that is connected externally. The speaker 55 emits the input audio signal as sound.

It is to be noted that the audio circuit 53, by the control of the control circuit 50, processes the audio signal that input from other audio devices 4 through the network 9 and outputs a processed audio signal to the power amplifier 54. Furthermore, the audio circuit 53 processes the audio signal played by the tuner 52 as an audio source and outputs a processed audio signal to the power amplifier 54. Moreover, the audio circuit 53 transmits the audio signal to the other audio devices 4 through the network 9. The input and output are executed as an MC link (trademark) at the time of the synchronous playing by a group. It is to be noted that such functions can be selected by a user separately from group play.

FIG. 4 is a block diagram of an audio device (multi zone device) 4-1 in a multi zone. In the multi zone device, a part having the same configuration as the part of the single zone device illustrated in FIG. 3 is designated by the same numeral, and a detailed description is omitted. The audio devices 4 in the multi zone, similarly to the single zone device, each also include a control circuit 50, an operation circuit 59, a wireless LAN communication circuit 56, a wireless LAN communication circuit 57, and a wired LAN communication circuit 58. The audio devices 4 in the multi zone each further have an audio processing circuit 60 that is extended more than the single zone device.

The audio processing circuit 60 of the audio device (multi zone device) 4-1, which covers a plurality of rooms (being used in a plurality of rooms), has a first audio apparatus 61 and a second audio apparatus 62. The first audio apparatus 61 and the second audio apparatus 62 configure a surround audio device of a multichannel (7.1 channels, for example). In the present preferred embodiment, the first audio apparatus 61 covers a Main Zone (the living room 70 in the present example), and the second audio apparatus 62 covers Zone 2 (the dining room 71 in the present example). In addition, in a case where the audio device 4-1 operates by a multichannel, the second audio apparatus 62 can provide surround back LR of the Main Zone. The first audio apparatus 61 and the second audio apparatus 62 each have an audio circuit 53 and a power amplifier 54. Each power amplifier 54 is connected to respective different speakers 55. In the present example, the speaker 55 of the first audio apparatus 61 is installed in the living room 70 and the speaker 55 of the second audio apparatus 62 is installed in the dining room 71. It is to be noted that the audio circuits 53 of the first audio apparatus 61 and the second audio apparatus 62 can be integrally configured.

The audio processing circuit 60 has a tuner 63 and a DVD drive 64 as a source that supplies content. The tuner 63 and the DVD drive 64 are connected to an assigner (selector) 67. The assigner 67 connects all the channels of the audio source selected by the operation circuit 59 or the controller 1 to the first audio apparatus 61, and selectively connects a channel (main channel) of a surround back LR channel and a front LR channel and to the second audio apparatus 62. Accordingly, in the second audio apparatus 62, the surround back LR of the audio that the first audio apparatus 61 can be synchronously played. Alternatively, a main channel sound that the first audio apparatus 61 can be synchronously played (Main Zone Sync).

Thus, the zone function of a multi zone device is a function that makes it possible to play main channel sound that is being played in the Main Zone, such as a dining, a bed room, or a different area of a large room, even with a speaker that is installed in a distance place. The zone function of a multi zone device is used, for example, when BGM is played in a larger area or when sound of a television that is placed in a living room is desired to be clearly listened to by a user who is cooking in a kitchen or doing laundry. The switch to zone play is performed mainly with an attached remote control.

The assigner 67, by the control of the control circuit 50, inputs to the first audio apparatus 61 the audio signal input from other audio devices 4 through the wireless LAN communication circuit 56 via the network 9. In addition, the assigner 67, by the control of the control circuit 50, can output a main channel sound to the second audio apparatus 62 through the first audio apparatus 61, using the above described zone function. Furthermore, the assigner 67 transmits the audio signal processed in the audio circuit 53 of the first audio apparatus 61 to the other audio devices 4 through the network 9 using the wireless LAN communication circuit 57. The input and output can be executed as an MC link (trademark) at the time of the synchronous playing by a group. It is to be noted that such functions can be selected by a user separately from group play.

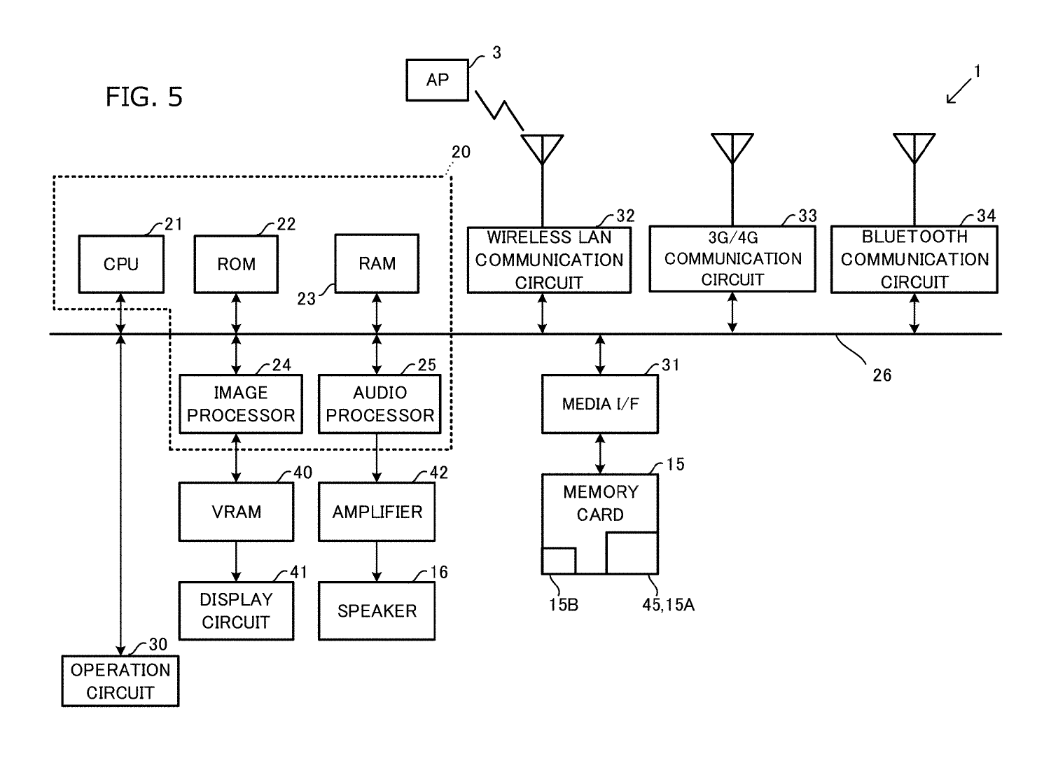

In FIG. 1, the portable phone 1 functions as an audio system controller by starting an audio system control program 45 (see FIG. 5). The controller 1 communicates with each of the audio devices 4 that belongs to the audio system 10, through the network 9. The controller 1, through such communication, controls an audio source to be played in each of the audio devices 4-1 to 4-3 in the audio system 10 (which of the audio devices 4 plays which music, which music is delivered to which of the audio devices 4, or the like, for example) and the sound volume, and the like, in an integrated manner.

In addition, in the controller 1, an audio source (audio signal) is transferred between a plurality of audio devices 4 by an operation of a user, and thus a group that performs synchronous playing among the plurality of audio devices 4 is set up. Such group setting is performed by selecting a room where each of the audio devices 4 is arranged. The controller 1, when a group is set up and synchronous playing by the group is instructed by a user, causes the audio devices 4 that are arranged in a selected room to synchronously play the same audio source. In the group setting, the multi zone device 4-1 can separately and independently select each zone since a separate room can be set with respect to each zone.

Subsequently, with reference to the block diagram in FIG. 5, a description will be made of a configuration of the controller (portable phone) 1, which can be a multifunctional telephone, namely known as a smartphone. The portable phone 1 has a 3G/4G communication function that is a portable communication network, a wireless LAN (Wi-Fi) communication function, and a Bluetooth (registered trademark) communication function. The portable phone 1, by starting the audio system control program 45 (application program), functions as a controller, communicates with the audio devices 4 of the audio system through the network 9, transmits a command message according to the operation of a user, to the audio devices 4, and controls the audio system.

The portable phone 1, on a bus 26, has a control circuit 20, an operation circuit 30, a media interface 31, a Wi-Fi communication circuit 32, a 3G/4G communication circuit 33, and a Bluetooth (registered trademark) communication circuit 34. The control circuit 20 includes a CPU 21, a ROM (flash memory) 22, a RAM 23, an image processor 24, and an audio processor 25. The image processor 24 is connected to a video RAM (VRAM) 40. The VRAM 40 is connected to a display circuit 41. The display circuit 41 includes a display of liquid crystal. The display displays a standby screen, a telephone number, and the like. In addition, in a case where the portable phone 1 functions as the controller, the display circuit 41 displays a screen for controlling the audio devices 4. The audio processor 25 is connected to an amplifier 42 including a D/A converter. The amplifier 42 is connected to a speaker 16.

The image processor 24 is provided with a GPU (Graphics Processing Unit) that generates various images such as a standby screen or a telephone number. The image processor 24, when the audio system control program 45 is started, generates the image of an audio controller according to instruction of the CPU 21, and develops the image on the VRAM 40. The image developed on the VRAM 40 is displayed on the display circuit 41.

The audio processor 25 has a DSP (Digital Signal Processor) that encodes and decodes telephone call sound. The audio processor 25 outputs a decoded or generated sound signal to the amplifier 42. The amplifier 42 amplifies the sound signal and outputs a resulting sound signal to the speaker 16.

The wireless LAN communication circuit 32 performs wireless communication with the access point 3 in conformity with IEEE 802.11g standard, and communicates with the audio devices 4 through the access point 3. The 3G/4G communication circuit 33 performs voice communication and data communication through a portable telephone communication network. The Bluetooth communication circuit 34 communicates with other Bluetooth compatible devices, and transmits and receives an audio signal, for example.

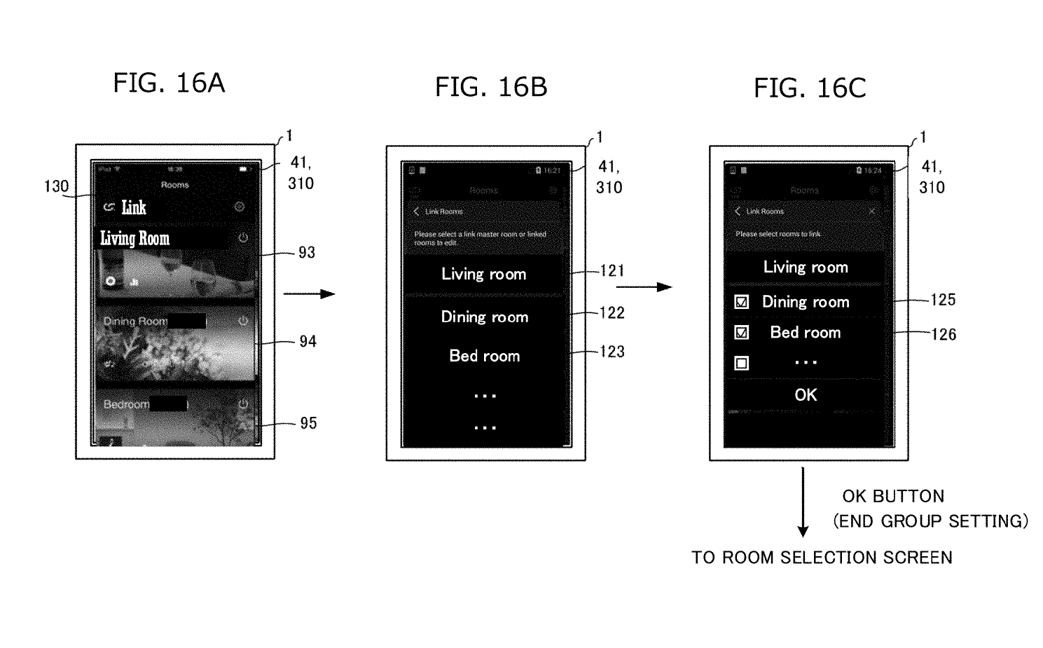

The operation circuit 30 includes a touch panel 310 (mainly see FIG. 16A to FIG. 16C) that is formed on the display circuit 41, and detects a touch operation and a flick operation on the touch panel 310, to provide a user interface. When the audio system control program 45 is started, a plurality of operation elements, such as a setup button or a scan button, are displayed on the display circuit 41. The operation circuit 30 detects the touch operation of a user and the coordinates of the operation by the touch panel 310, and determines which operation element has been operated.

The media interface 31 is connected to a memory card 15. The memory card 15 can be a micro SD card, for example. The audio system control program 45 can be stored in the memory card 15 or the ROM 22. In the present embodiment, as illustrated in FIG. 5, the audio system control program 45 is stored in a program storage area 15A of the memory card 15. It is to be noted that the audio system control program 45 can be downloaded through the 3G/4G data communication or the wireless LAN data communication or can be stored in advance in the ROM 22 or the memory card 15. In addition, the memory card 15 includes a storage area 15B that stores the configuration of the audio system.

The ROM 22 stores a basic program for executing a telephone call and an application program of the portable phone 1. The ROM 22 is a flash memory, and besides the basic program, can also store an application program that has been downloaded. The RAM 23 has a work area that is used when the CPU 21 executes the audio system control program 45.

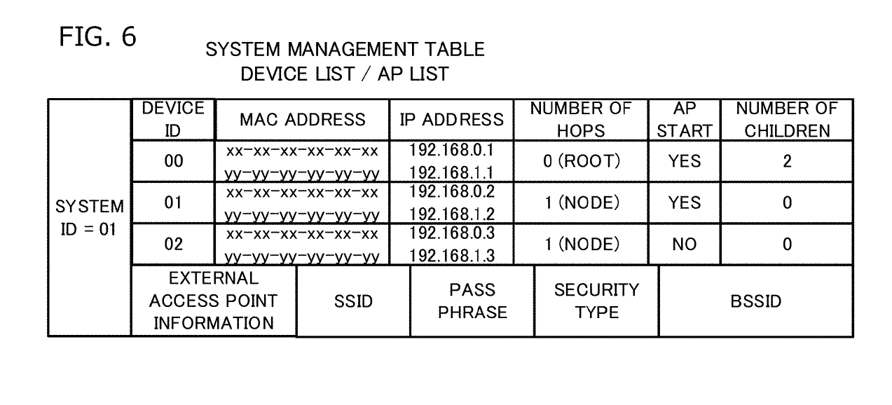

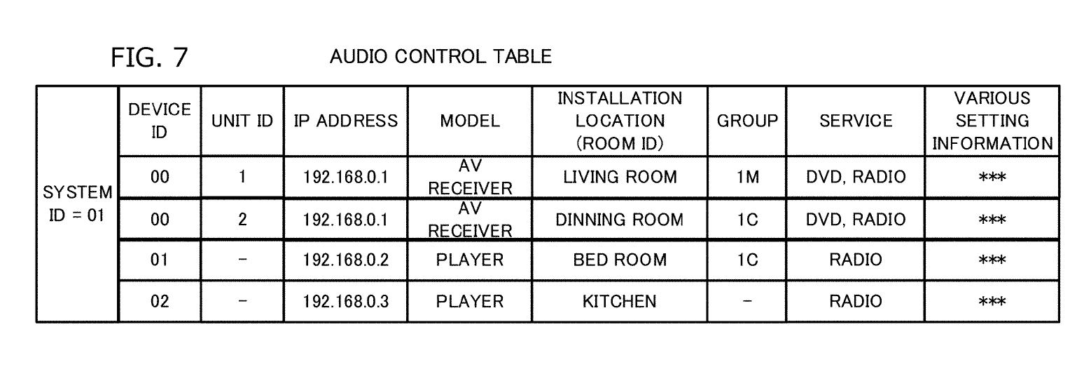

FIG. 6 and FIG. 7 each illustrate an example of a table that manages the audio system 10. FIG. 6 is a system management table that manages the connection configuration of each of the audio devices 4 in the network 9. In addition, FIG. 7 is an audio control table that manages the arrangement and operation of each of the audio devices 4 that configures the audio system 10. The system management table is used mainly by the audio device 4-1 being a root device to manage network connection. In addition, the audio control table is used, mainly by the controller 1, to control the play of an audio source. The audio device 4-1 being a multi zone device is treated as one device in the system management table, and is managed for each zone (unit) in the audio control table.

The system management table illustrated in FIG. 6 stores the connection configuration of each of the audio devices 4 configuring the audio system 10, and can be created by the controller 1 at the time of configuration of the audio system 10. In addition, when a new audio device is added to the audio system 10, the controller 1 updates the system management table by adding the new audio device. The system management table that has been created or added and updated is transmitted from the controller 1 to the audio device 4-1 being a root device.

The system management table is identified by a system ID for identifying the audio system 10. Each of the audio devices 4 is associated with a device ID on a one-to-one basis. Accordingly, each of the audio devices 4 stores information, such as the higher-level side (slave machine side) and lower-level side (internal access point side) MAC address (of each of the wireless LAN communication circuits 56 and 57), the higher-level side and lower-level side IP address (of each of the wireless LAN communication circuits 56 and 57), the number of connection stages (the number of HOPs) from the audio device 4-1 being a root device, the presence or absence of start of an internal access point, or the number of lower-level devices (the number of children) connected to the internal access point 4A. In the system management table of FIG. 6, the multi zone device 4-1 being a root device is a device of device ID=00, and is registered as one set of an audio device regardless of the number of audio apparatuses to be incorporated. Then, communication with all the audio apparatuses is performed by the same IP address (through the same wireless LAN communication circuit 56, wireless LAN communication circuit 57, or wired LAN communication circuit 58).

It is to be noted that, while each of the audio devices 4 has an individual IP address, the audio system 10 has a multicast address that is set up as a multicasting group. Each of the audio devices 4, by transmitting an IP packet of the system information to the multicast address, is able to cause all the audio devices 4 of the audio system 10 to receive a system information packet. It is to be noted that, although each of the audio devices 4 can transmit the system information packet to the IP address of each of the audio devices 4 by unicast, each of the audio devices 4, by transmitting the system information packet to the IP address by multicast, can reduce the load of the network 9.

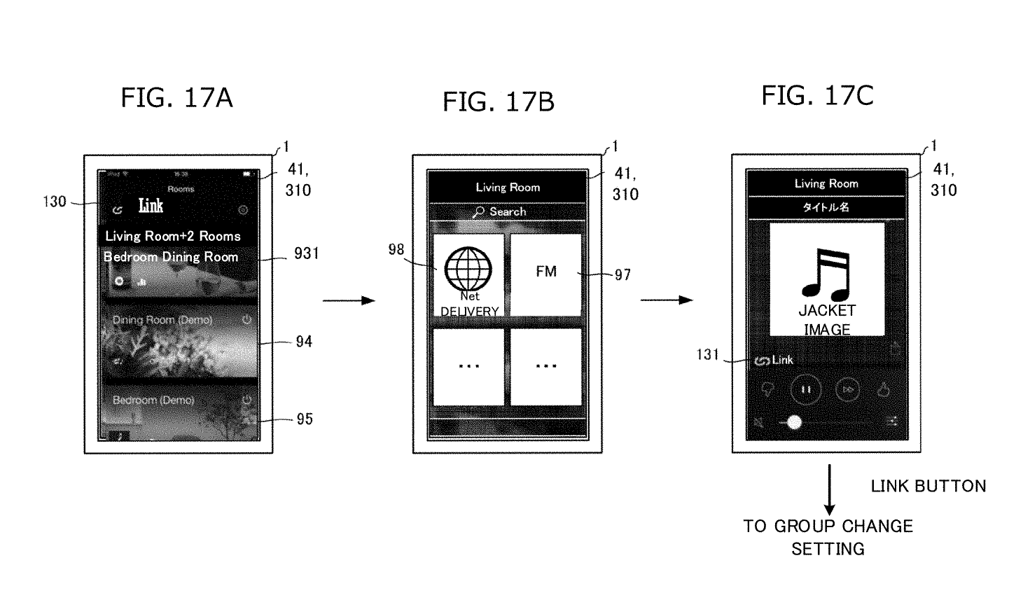

The audio control table illustrated in FIG. 7 associates a device with a device ID and a zone number, and stores various types of setting information such as the higher-level side IP address (the IP address of the wireless LAN communication circuit 56) of each of the audio devices, a model, an installation location (room), a group, service, a volume value, and a display name. Each column of the audio control table and each column of the system management table are associated with each other by the device ID. In the case of the multi zone device 4-1, one set of the audio device can have a plurality of audio apparatuses, and each of the audio apparatuses can be assigned to a separate room. The controller 1, based on the details of the audio control table, creates the control screen illustrated in FIG. 16A to FIG. 16C and FIG. 17A to FIG. 17C, and receives an operation by a user.

The installation location is information that specifies a room (area) where the audio device is installed. Although a room name is displayed in the table of FIG. 7, the information of the installation location can be, for example, a room ID of the room where the audio device is currently installed.

The group is information of a group to which each of the audio devices or the audio apparatus belongs, and indicates a group that performs synchronous playing of the above described content. It is to be noted that group setting by a user is performed not by directly specifying an audio device or an audio apparatus but by specifying a room, so that an audio device or an audio apparatus that is currently installed in the room is specified indirectly. The group can include one set of a master that delivers content (an audio signal) of an audio source to each of the audio devices in the group and to an audio apparatus, and one or more clients that receive an audio signal from the master and emit sound into the room.

The master takes charge of the supply of an audio source to the entire group and the control of synchronous playing. In addition, the master functions as a device that also performs synchronous playing. A client treats a master as an audio source, receives an audio signal from the master, and processes the audio signal in the audio processing circuit and then emits sound. In the item of the “group” in the audio control table, the number of the group to which the device belongs, and the type of master (M) and client (C) are stored. For example, “1M” stored in the column of unit ID=1 of the device ID=00 (audio device 4-1) of FIG. 7 indicates a master of the group of group number 1.

The service is information indicating an audio source that each of the devices 4 is able to play. As illustrated in FIG. 6 and FIG. 7, the audio device 4-1 of device ID=00 is able to play a DVD, radio (including an FM broadcast or a net radio), and various types of network content. The audio device 4-2 and the audio device 4-3 of device ID=01 and device ID=02 can play Radio and various types of network content. It is to be noted that, although not described in the item of service in the audio control table, each audio device (audio apparatus), when being a client of group play, receives an audio signal from other audio devices (other audio apparatuses). In other words, each audio device (audio apparatus) plays (emits the sound of) a received audio signal using the other audio devices (other audio apparatuses) as an audio source (service). In a case where one of two audio devices 4 is a master and the other is a client, both audio devices 4 transmit and receive an audio signal through the network 9. In a case where the first audio apparatus 61 of the multi zone device 4-1 is a master and the second audio apparatus 62 is a client, the second audio apparatus 62, with the connection configuration that is called Main Zone Sync, inputs the audio signal of the first audio apparatus 61.

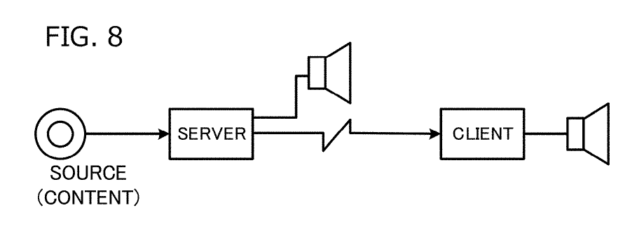

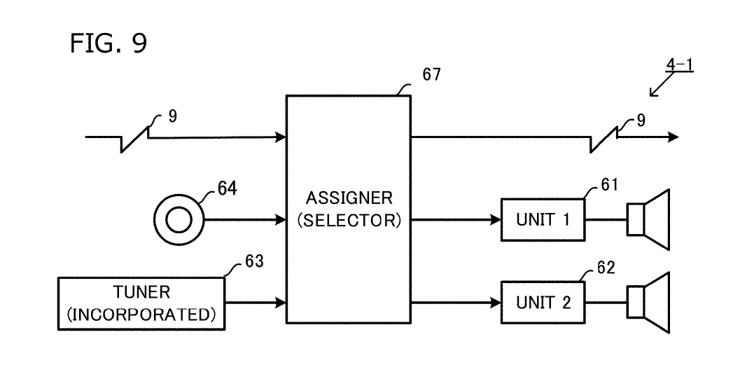

Hereinafter, a description will be made of play of content by a group including the multi zone device 4-1. FIG. 8 is a diagram illustrating a configuration of play by a general group. FIG. 8, to make the explanation easier to understand, illustrates only one client but the number of clients is not limited. A master plays a predetermined (selected by a user) audio source (content of an audio source), and emits the sound of a reproduced audio signal by itself. Furthermore, the master transmits the reproduced audio signal to a client through the network 9. The client emits the sound of the audio signal received from the master. Subsequently, FIG. 9 is a diagram illustrating the function of the assigner 67 of the multi zone device 4-1 illustrated in FIG. 4. The assigner 67 has an input circuit, and is connected to the tuner 63, the DVD drive 64, the network 9, and an output circuit of the audio circuit 53 of the first audio apparatus 61. In addition, the assigner 67 further has an output circuit. The output circuit of the assigner 67 is connected to the first audio apparatus (Unit 1) 61, the second audio apparatus (Unit 2) 62, and the network 9. The assigner 67, according to an instruction of the control circuit 50, based on a command of the controller 1, assigns the signal input to the input circuit, to the first audio apparatus 61, the second audio apparatus 62, and the network 9 that are connected to the output circuit.

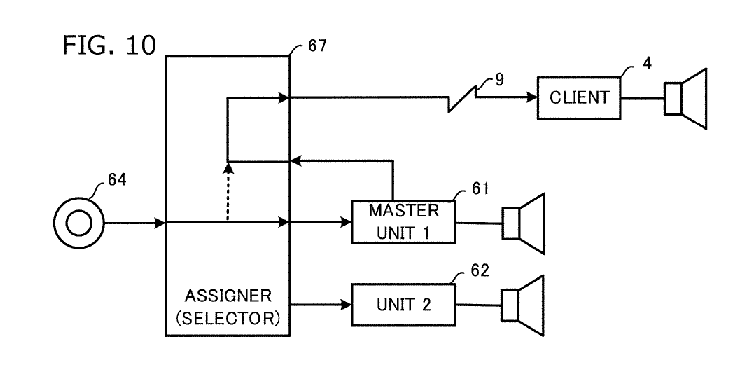

FIG. 10 illustrates a configuration of group play in a case where the first audio apparatus 61 (main zone) of the multi zone device 4-1 is a master and other audio devices 4 are clients. The first audio apparatus 61 is connected to a predetermined (selected by a user) audio source (DVD drive 64, for example). The first audio apparatus 61 plays and emits the sound of the predetermined audio source, and inputs a reproduced audio signal to the assigner 67. The assigner 67 transmits the reproduced audio signal to a client 4 through the network 9. The client 4 emits the sound of an audio signal received through the network 9. The first audio apparatus 61, to synchronize the play timing with the client 4 that receives an audio signal through the network 9, delays the audio signal for a predetermined period of time and then emits sound. It is to be noted that the assigner 67 can directly connect the audio source to be connected to the first audio apparatus 61, to the network 9 and can transmit a play signal to the client (see the dotted line). It is to be also noted that, since the second audio apparatus 62 is not selected as a client, the second audio apparatus 62 does not play an audio source. It is to be also noted that the second audio apparatus 62, when functioning as a surround speaker of the first audio apparatus 61 (main zone), can output the sound of surround back LR.

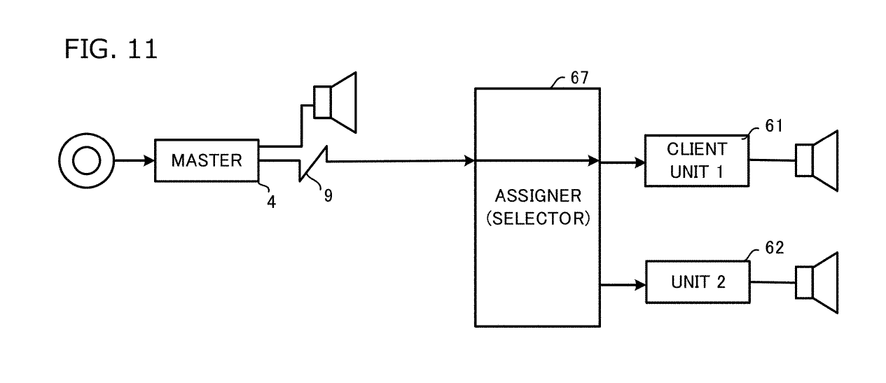

FIG. 11 illustrates a configuration of group play in a case where other audio devices 4 are masters and the first audio apparatus 61 of the multi zone device 4-1 is a client. The other audio devices 4 being masters play and emit the sound of a predetermined (selected by a user) audio source, and transmits a reproduced audio signal to the multi zone device 4-1 through the network 9. In the multi zone device 4-1, the first audio apparatus 61 is a client. The assigner 67 inputs the audio signal to the first audio apparatus 61. Furthermore, the first audio apparatus 61 emits the sound of the audio signal. It is to be noted that, since the second audio apparatus 62 is not selected as a client, the second audio apparatus 62 does not play an audio source. It is to be also noted that the second audio apparatus 62, when functioning as a surround speaker of the first audio apparatus 61 (main zone), can output the sound of surround back LR.

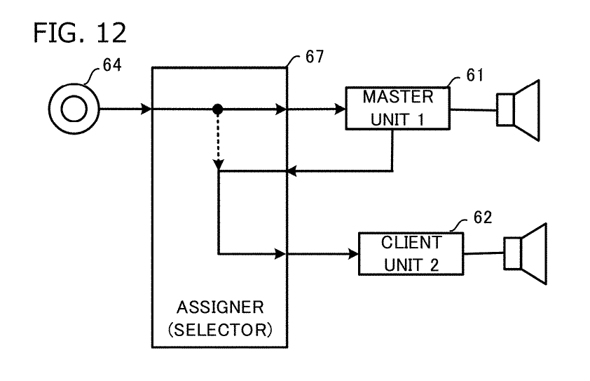

FIG. 12 illustrates a configuration of group play in a case where the first audio apparatus 61 (main zone) of the multi zone device 4-1 is a master and the second audio apparatus 62 is a client. The configuration, using the above described zone function, operates as if an audio signal is delivered from the room of the master to the room of the client. The first audio apparatus 61 is connected to a predetermined (selected by a user) audio source (DVD drive 64, for example). The first audio apparatus 61 plays and emits the sound of the predetermined audio source, and inputs a reproduced audio signal to the assigner 67. The assigner 67 outputs an input audio signal to the second audio apparatus 62. The second audio apparatus 62 emits the sound of the audio signal. It is to be noted that the assigner 67 can also directly connect the audio source to be connected to the first audio apparatus 61 to the second audio apparatus 62 and can directly input an audio signal to the second audio apparatus 62 (see the dotted line).

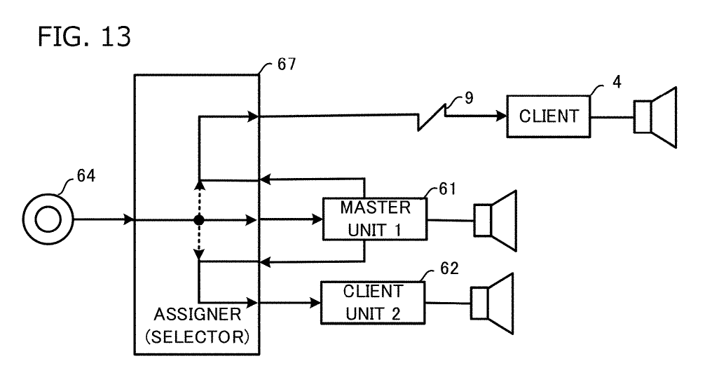

FIG. 13 illustrates a configuration of group play in a case where the first audio apparatus 61 of the multi zone device 4-1 is a master and the second audio apparatus 62 and other audio devices 4 are clients. The first audio apparatus 61 is connected to a predetermined (selected by a user) audio source (DVD drive 64, for example). The first audio apparatus 61 plays and emits the sound of the predetermined audio source, and inputs a reproduced audio signal to the assigner 67. The assigner 67 transmits an input audio signal to a client through the network 9. Furthermore, the assigner 67 also outputs to the second audio apparatus 62 using the zone function. The second audio apparatus 62 and the client 4 emit the sound of the audio signal. The first audio apparatus 61 and the second audio apparatus 62, to synchronize the play timing with the client 4 that receives an audio signal through the network 9, delay the audio signal for a predetermined period of time and then emit sound. It is to be noted that the assigner 67 can directly connect the audio source to be connected to the first audio apparatus 61, to the network 9 and the second audio apparatus 62 (see the dotted line).

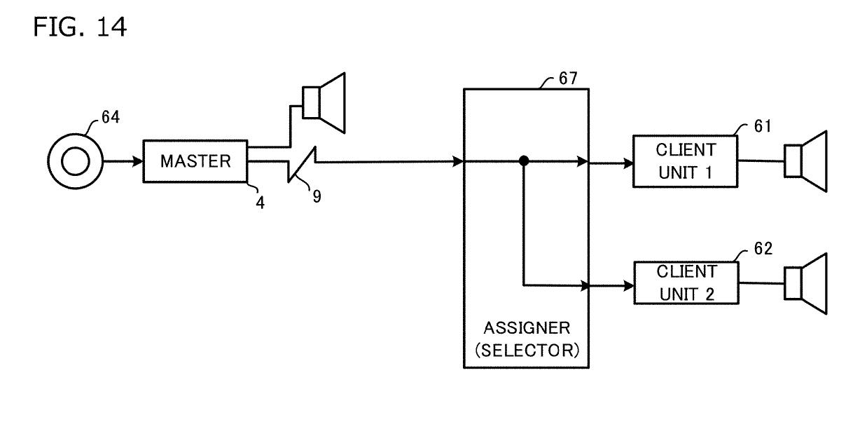

FIG. 14 illustrates a configuration of group play in a case where other audio devices 4 are masters and the first audio apparatus 61 of the multi zone device 4-1 and the second audio apparatus 62 are clients. The other audio devices 4 being masters play and emit the sound of a predetermined (selected by a user) audio source, and transmits a reproduced audio signal to the multi zone device 4-1 through the network 9. In the multi zone device 4-1, both the first audio apparatus 61 and the second audio apparatus 62 are clients. The assigner 67 outputs a received audio signal to the first audio apparatus 61, and outputs the received audio signal also to the second audio apparatus 62 using the zone function. The first audio apparatus 61 and the second audio apparatus 62 emit the sound of the audio signal.

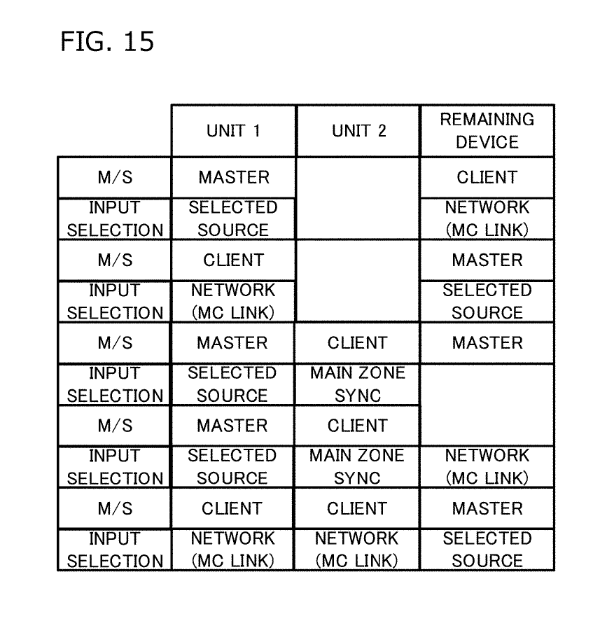

FIG. 15 is a table that summarizes selection of inputs in a group of the configuration illustrated in FIG. 10 to FIG. 14. The controller 1 stores the table as illustrated in FIG. 15, according to the configuration of the group to which play has been instructed by the user, creates a command to select an input to each device of a master and a client, and transmits the command.

While the above examples do not include an example where the second audio apparatus 62 is a master, group setting where the second audio apparatus 62 can enable it as a master. In addition, aside from the example, the second audio apparatus 62 can prohibit group setting from setting the second audio apparatus 62 as a master. Moreover, while the above examples do not include an example where the second audio apparatus 62 alone makes a client of other audio devices 4, group setting of such a configuration can be allowed. Furthermore, aside from the example, the second audio apparatus 62 can prohibit the group setting of such a configuration.

Subsequently, a description will be made of a control procedure (play procedure and group setting procedure) of one of the audio devices 4 using a controller 1 with reference to a control screen (the display details of the display circuit 41) illustrated in FIG. 16A, FIG. 16B, FIG. 16C, FIG. 17A, FIG. 17B, and FIG. 17C. FIG. 16A to FIG. 16C each illustrate an example of a control screen at the time of group setting. FIG. 17A to FIG. 17C each illustrate an example of a control screen at the time of play control after the group setting.

A description will be made of a group setting procedure. In the group setting procedure, a master and client of a group are selected. The controller 1 first displays a room selection screen (list screen) illustrated in FIG. 16A. On the room selection screen, room selection buttons 93, 94, and 95 to select one of the rooms where an audio device (audio apparatus) is installed are displayed. When one of the room selection buttons is tapped (operated), selection of content and play are performed by the audio device (audio apparatus) that is installed in the room. In addition, the room selection screen displays a link (Link) button 130. When the link button 130 is tapped, the group setting procedure is started. When the link button 130 is selected, the group setting procedure is started and a master room selection screen illustrated in FIG. 16B is displayed. The master room selection screen displays master room selection buttons 121, 122, and 123 for selecting a master as a supply source of an audio source (content) that is synchronously played in a group. When the master room selection button 121 is operated, for example, on the screen, a living room is selected as a master room, and the first audio apparatus 61 of the audio device 4-1 becomes a master for synchronous playing. It is to be noted that, while, in FIG. 16B, only the three buttons 121 to 123 are displayed as master room selection buttons to facilitate understanding, all buttons of a room that is able to be selected as a master can be displayed.

When a master room is selected, a screen display is switched to a client room selection screen illustrated in FIG. 16C. The client room selection screen displays a client room selection button 125 and a client room selection button 126 for selecting a client of the group. When the client room selection button 125 or the client room selection button 126 is tapped, a check mark is displayed on a check box in the button that has been tapped and a checked item is in a selected state. FIG. 16C illustrates a state where both the client room selection button 125 and the client room selection button 126 have been tapped or selected. In such a case, a check mark is displayed on the check box of both the client room selection button 125 and the client room selection button 126, and a dining room and a bedroom serve as a client room. Furthermore, the second audio apparatus 62 of the audio device 4-1 and the audio device 4-2 serve as a client.

After the above procedure, when the user operates a determination (OK) button 126, the group setting is thus completed. Then, the information of the group is registered in the audio control table illustrated in FIG. 7. After completing a group setting operation, the control screen returns from the client room selection screen illustrated in FIG. 16C to the room selection screen.

While the example of FIG. 16A, FIG. 16B, and FIG. 16C illustrates a case where the multi zone device 4-1 and a single zone device 4-2 are grouped, single zone devices also can be grouped by a similar operation. In addition, in a case where a plurality of multi zone devices are present, the plurality of multi zone devices can be grouped in the same manner as described above.

FIG. 17A illustrates an example of the room selection screen in a case where a group setting is present. When a group is set up, the group setting is also reflected in the room selection screen. In other words, in the example of FIG. 17A, the room name (Bed Room and Dining Room) of a client room is added to a room selection button 931 of the living room 70 as a master room. The room selection button 931 is a selection button of a group (Living Room+2 Rooms). The room selection button 931 indicates that the group includes not only the living room 70. In addition, the room selection button 931 has a background image to which a blur is added, to make it easy to be identified. The display mode of the room selection button 931 is the result of reflecting the group setting written into the table of the FIG. 7. The writing of the group setting to the table of FIG. 7 is performed by the procedure illustrated in FIG. 16A, FIG. 16B, and FIG. 16C. In addition, the room selection button 94 of the dining room 71 as a client room and the room selection button 95 of the bed room 72 are grayed out and are not able to be operated.

In a case where the room selection button 931 of a living room group is tapped on or selected from the room selection screen illustrated in FIG. 17A, a source selection screen of the audio device 4-1 (first audio apparatus 61) being a master as illustrated in FIG. 17B is displayed. After a source is selected on the source selection screen of FIG. 17B, a play screen as illustrated in FIG. 17C is displayed, and synchronous playing in the first audio apparatus 61 of the audio device 4-1, the second audio apparatus 62, and the audio device 4-2 in the living room 70, the dining room 71, and the bed room 72 is executed.

While the example of FIG. 17A, FIG. 17B, and FIG. 17C illustrates a case where a group play is performed by a group configured by the multi zone device 4-1 and the single zone device 4-2, a group play by a group configured by only single zone devices also can be performed by a similar operation. In addition, in a case where a group play by a group including a plurality of multi zone devices is to be performed, is also performed in the same manner as described above.

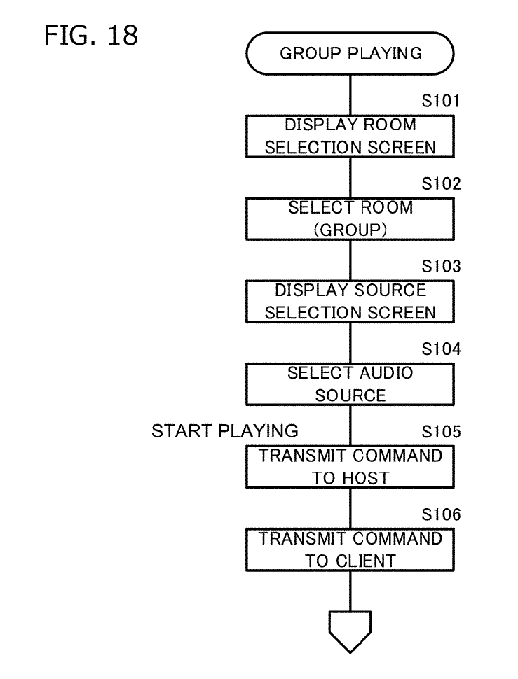

Subsequently, a description will be made of a processing operation at the time of group play of the controller 1 (control circuit 20) with reference to FIG. 18. In the example, a description will be made of processing when the living room group (Living Room +2 Rooms) illustrated in FIG. 17A is selected. The controller 1 displays a room selection screen illustrated in FIG. 17A on the display circuit 41 (S101). When a room selection button 931 to select the living room group is pressed by a user (S102), the controller 1 displays the source selection screen illustrated in FIG. 17B (S103). When one of audio sources is selected by the user (S104), a command to start group play of the content of the audio source to a master and a client is transmitted (S105, S106). In other words, the controller 1 determines a device to be in charge of a master and a device to be a client based on the audio control table of FIG. 7, and plays the audio source selected by the user. Furthermore, the controller 1 transmits to the master a command to instruct the master to transmit an audio signal of a played audio source to the client (S105). Then, the controller 1, with reference to the table of FIG. 15, transmits to each client a command to select an input so that the audio signal of the master can be input (S106). It is to be noted that the controller 1, at the time of grouping, is able to omit a table by fixedly setting the input of the second audio apparatus 62 to Main Zone Sync.

Moreover, while, in the above-described embodiment, one audio device is installed in every room, a plurality of sets of audio devices can be installed in one room. Furthermore, while the illustrated embodiments the audio system 10 where only one multi zone device (4-1) is present, there is no limitation in the number of multi zone devices in the present invention. In a case where a group is formed by combining a multi zone device and other devices, the other devices can be multi zone devices.

It is to be noted that the audio device according to the present invention can be an audio visual (AV) device with a video play function or can include a system where the audio device and such an AV device are mixed. Moreover, while, in the illustrated embodiments, the control terminal is achieved by the portable phone 1 with the installed audio system control program (application program), the control terminal can be achieved by a configuration other than a portable phone. For example, the control terminal can be a tablet in which the audio system control program is installed or can be an exclusive terminal device.

The foregoing embodiments are illustrative in all points and should not be construed to limit the present invention. The scope of the present invention is defined not by the foregoing preferred embodiment but by the following claims. Further, the scope of the present invention is intended to include all modifications within the scopes of the claims and within the meanings and scopes of equivalents.

What is claimed is:

1. A control terminal comprising:
at least one memory storing instructions; and
at least one processor configured to implement the stored instructions and execute plurality of tasks, including:
a receiving task that receives a group setting for a first device having a main channel and a sub channel, from among a plurality of devices, and sets the main channel and the sub channel as respective separate groups; and
a transmitting task that transmits a command related to the group setting to at least the first device.

2. The control terminal according to claim 1, wherein the transmitting task transmits a command related to the group setting to at least one device other than the first device, from among the plurality of devices.

3. The control terminal according to claim 1, wherein the first device is a multi zone device having a zone function to output a same signal output to the main channel, to the sub channel.

4. The control terminal according to claim 1, wherein the group setting has at least one device, from among the plurality of devices, set as a master that reproduces and transmits an audio signal, and at least another device other than the master, from among the plurality of devices, set as a client that receives and reproduces the audio signal from the master.

5. The control terminal according to claim 1, wherein the plurality of tasks include a playing task that causes all grouped devices, among the plurality of devices, that are grouped with the group setting to synchronously play a same content.

6. A system comprising:
the control terminal according to claim 1; and
the plurality of devices,
wherein the first device transmits a signal to another device, from among the plurality of devices.

7. The system according to claim 6, wherein the first device, from the main channel, outputs to the sub channel the signal, using a zone function to output a same signal output to the main channel, and performs synchronous playing between the main channel and the sub channel.

8. A system comprising:
the control terminal according to claim 1; and
the plurality of devices including a second device that is different from the first device,
wherein the first device includes:
a first apparatus configured for the main channel; and
a second apparatus configured for the sub channel, and
wherein the transmission task transmits commands that select a source individually for each of the first apparatus and the second apparatus.

9. The system according to claim 8, wherein the group setting has at least one of the first apparatus or the second apparatus, or the second device set as a master that reproduces and transmits an audio signal, and at least another device, from among the plurality of devices, or at least one of the first apparatus or the second apparatus, other than the master, set as a client that receives and reproduces the audio signal from the master.

10. The system according to claim 9, wherein:
the first device is a multi zone device having a zone function to output to the sub channel the same audio signal output to the main channel,
the group setting has the first apparatus set as a master, and the second apparatus and the second device set as clients,
the transmitting task transmits to the first device:
a command to reproduce a predetermined audio source in the first apparatus;
a command to transmit an audio signal related to the reproduced audio source, to the second device; and
a command to input the audio signal output from the first apparatus to the second apparatus and reproduce the audio signal in the second apparatus; and
the transmitting task transmits to the second device:
a command to reproduce the audio signal received from the first device.

11. The system according to claim 9, wherein:
the first device is a multi zone device having a zone function to output to the sub channel the same audio signal output to the main channel,
the group setting has the second device set as a master and the first apparatus and the second apparatus set as clients,
the transmitting task transmits to the second device:
a command to reproduce a predetermined audio source,
a command to transmit an audio signal related to the reproduced audio source, to the first device, and
the transmitting task transmits to the first device:
a command to reproduce the audio signal received from the second device, in the first apparatus and the second apparatus.

12. A method of controlling a system, the method comprising:
a receiving step of receiving a group setting for a first device having a main channel and a sub channel, from among a plurality of devices, and setting the main channel and the sub channel as respective separate groups; and
a transmitting step of transmitting a command related to the group setting to at least the first device.

13. The method according to claim 12, wherein the transmitting step transmits a command related to the group setting to at least one device other than the first device, from among the plurality of devices.

14. The method according to claim 12, wherein the first device is a multi zone device having zone function to output a same signal output to the main channel, to the sub channel.

15. The method according to claim 12, wherein the group setting has at least one device, from among the plurality of devices, set as a master that reproduces and transmits an audio signal, and at least another device other than the master, from among the plurality of devices, set as a client that receives and reproduces the audio signal from the master.

16. The method according to claim 12, further comprising a playing step of causing all grouped devices, from among the plurality of devices, that are grouped with the group setting to synchronously play a same content.

17. The method according to claim 12, wherein:
the plurality of devices include a second device that is different from the first device, the first device includes:
a first apparatus configured for the main channel; and
a second apparatus configured for the sub channel, and
the transmission step transmits commands that select an audio source individually for each of the first apparatus and the second apparatus.

18. The method according to claim 17, the group setting has at least one of the first apparatus or the second apparatus, or the second device set as a master that reproduces and transmits an audio signal, and at least another device, from among the plurality of devices, or at least one of the first apparatus or the second apparatus, other than the master, set as a client that receives and reproduces the audio signal from the master.

19. The method according to claim 18, wherein:
the first device is a multi zone device having a zone function to output to the sub channel the same audio signal output to the main channel,
the group setting has the first apparatus set as a master and the second device and the second apparatus set as clients,
the transmitting step transmits to the first device:
a command to reproduce a predetermined audio source in the first apparatus;
a command to transmit an audio signal related to the reproduced audio source, to the second device; and
a command to input the audio signal output from the first apparatus to the second apparatus and reproduce the audio signal in the second apparatus; and
the transmitting step transmits to the second device:
a command to reproduce the audio signal received from the first device.

20. The method according to claim 18, wherein:
the first device is a multi zone device having a zone function to output to the sub channel the same audio signal output to the main channel,
the group setting has the second device set as a master and the first apparatus and the second apparatus set as clients,
the transmitting step transmits to the second device:
a command to reproduce a predetermined audio source; and
a command to transmit an audio signal related to the reproduced audio source, to the first device; and
the transmitting step transmits to the first device:
a command to reproduce the audio signal received from the second device, in the first apparatus and the second apparatus.
